(19) United States
(12) Patent Application Publication
(10) Pub. No.: US 2009/0252147 A1
(43) Pub. Date: Oct. 8, 2009

(54) STORAGE SERVER IMPLEMENTED BY INTERNET SMALL COMPUTER SYSTEMS INTERFACE IN LINUX SYSTEM

(75) Inventors: He ZHANG, Tianjin (CN); Tom CHEN, Taipei (TW); Win-Harn LIU, Taipei (TW)

Correspondence Address: Workman Nydegger;1000 Eagle Gate Tower, 60 East South Temple, Salt Lake City, UT, 84111, US

(73) Assignee: INVENTEC CORPORATION, Taipei (TW)

(21) Appl. No.: 12/061,821

(22) Filed: Apr. 3, 2008

(51) Int. Cl. H04L 12/28

(52) U.S. Cl. 370/351

(57) ABSTRACT

A storage server implemented by an internet small computer systems interface (iSCSI) in a Linux system includes a network subsystem and a small computer systems interface (SCSI) subsystem, and an iSCSI module and a SCSI module are respectively embedded in the network subsystem and SCSI subsystem. When receiving a link request packet from an initiator, the network subsystem creates a SCSI identifiable format packet for the SCSI subsystem by the embedded iSCSI module and the embedded SCSI module. The iSCSI module and SCSI module are respectively embedded in the network subsystem and SCSI subsystem. The iSCSI module and SCSI module can be immediately called without waiting the switch of processing, thereby solving performance bottleneck in the storage server and improving the operation speed of the storage server.

### BACKGROUND OF THE INVENTION

1. Field of Invention

The present invention relates to a storage server, and more particularly to a storage server implemented by an internet small computer systems interface (iSCSI) in a Linux system.

2. Related Art

Along with the rapid development of the hard disk technique, the hard disk space is improved from mega byte (MB) to giga byte (GB). With the progress of the network technique, a communication protocol standard on iSCSI is proposed by IETF, for serially connecting a plurality of computer hosts to form a virtual network storage server based on the TCP/IP communication protocol. The virtual network storage server has a high speed transmission capability and an expanding/backup capability for ever-expanding capacity of the virtual storage device. The storage server implemented by the iSCSI communication protocol can be formed by one or more targets. The operation of accessing data storage once is called a session. The terminal which initiating the session is called initiator. The initiator transmits a request packet to establish the session with the target, and the target receives the request packet to respond and establish a session link.

FIG. 1 is a schematic view of system architecture of a target in the storage server. When transmitted to a target 100 through the TCP/IP network, a request packet must pass through a network subsystem 110, an iSCSI module 120, and a SCSI module 130, and then is transferred to the SCSI subsystem 140. The iSCSI module 120 has independent executor for parsing the SCSI instructions and data from the iSCSI packet parsed by the network subsystem 110. Then, the SCSI instructions and data are parsed by the SCSI module 130. After finishing parsing, the SCSI module 130 submits the parsing results to the SCSI subsystem 140, and creates the response data (i.e. the result after executing the SCSI instruction and the data) after the parsing results are executed by the SCSI subsystem 140. The above layers perform the process switch in a handshaking manner, and each layer plays a role of request/response. For example, after the target 100 receives the network packet, the network subsystem 110 sends a request packet (or signal) to inform the iSCSI module 120 to switch to the role for parsing the iSCSI packet data in the network packet, and the iSCSI module 120 responds to the request. After receiving the request of the iSCSI module 120, the SCSI module 130 executes the SCSI instruction and the data after parsing, and initiates a request to make the SCSI subsystem 140 to submit the execution result. Under the network environment of mass transmission (high pressure environment), the handshaking processing manner may greatly increase the times of the process switch. Each link request must perform the process switch among the layers. Particularly, the iSCSI module 120 and the SCSI module 130 must receive the link request of the lower layer (the network subsystem 110) and submit the execution result to the upper layer (the SCSI subsystem 140) on one hand, and must transmit the response packet (signal) to respond the request of the lower layer on the other hand. The frequent process switch results in the performance bottleneck of the storage server, such that the executing speed of the storage server is lowered.

### SUMMARY OF THE INVENTION

In view of the above, the target in the storage server establishes the session through the complicated handshaking procedure (transmitting the request and waiting the response) of elements of each layer, so the frequent process switch of the elements of each layer easily results in the performance bottleneck of the storage server. Thus, the iSCSI layer and the SCSI layer functions are embedded into the network subsystem and the SCSI subsystem through the embedded modules of the network subsystem and the SCSI subsystem, such that the network subsystem and the SCSI subsystem are independent executors respectively, so as to avoid the frequent process switch among the layers and prevent multiple times of memory data copy actions among the layers. The copy actions among the layers are not required in the course of data transmission, thereby saving the time for data transmission, and improving the overall operation performance.

In order to achieve the objective, the storage server implemented by the iSCSI in the Linux system includes two parts, namely a network subsystem and a SCSI subsystem.

The first part is the network subsystem that receives the network packet from the initiator. The iSCSI module and the SCSI module are embedded in the network subsystem. When the iSCSI module is called by the network subsystem, the network packet is determined to be an iSCSI request packet, and the SCSI request instruction or the SCSI data is parsed. The SCSI module is called by the iSCSI module, the SCSI request instruction or the SCSI data is received, and is packed to a SCSI subsystem identifiable format packet.

The second part is the SCSI subsystem that receives the SCSI identifiable format packet and returns the network subsystem identifiable format packet to the network subsystem to finish the receiving procedure. The SCSI module and the iSCSI module are embedded in the SCSI subsystem. The SCSI module is called by the SCSI subsystem, for determining that the instruction transmitted by SCSI subsystem is the response instruction. Next, the SCSI module calls the iSCSI module. According to the response instruction, the iSCSI module creates the iSCSI response format data, packs the iSCSI response format data into the network subsystem identifiable format packet, and transmits the network subsystem identifiable format packet to the network subsystem.

In the storage server implemented by the iSCSI in the Linux system according to a preferred embodiment of the present invention, the iSCSI module embedded in the network subsystem determines that the received network packet is not the iSCSI request packet, the network packet is transmitted to the network subsystem to execute the standard packet parsing flow. In addition, when the SCSI module embedded in the SCSI subsystem determines that the instruction transmitted by the SCSI subsystem is not the response instruction, the SCSI subsystem submits the response to the related application through the standard flow.

In the storage server implemented by the iSCSI in the Linux system according to a preferred embodiment of the present invention, the network packet is the data packet of the TCP layer, and the iSCSI request packet is the iSCSI packet containing the iSCSI request instruction.

In the storage server implemented by the iSCSI in the Linux system according to a preferred embodiment of the present invention, the SCSI module of the network subsystem transmits the SCSI identifiable format packet to the SCSI subsystem by calling an interface provided by the SCSI subsystem. The iSCSI module of the SCSI subsystem transmits the network subsystem identifiable format packet by calling an interface provided by the network subsystem.

Accordingly, in the storage server implemented by the iSCSI in the Linux system of the present invention, the iSCSI module and the SCSI module are embedded in the network subsystem and the SCSI subsystem respectively, for exclusively performing receiving or sending process. Each module does not need to perform the process switch of receiving or sending (switching to the initiator that transmits the request/responds the instruction), thereby solving the system performance bottleneck resulting from the process switch. In addition, the operations of the initiator (the network subsystem and the SCSI subsystem) requesting and responding the task are independent, so the instruction requesting and initiating can be operated in parallel, thereby improving the processing speed of the overall storage server.

### BRIEF DESCRIPTION OF THE DRAWINGS

The present invention will become more fully understood from the detailed description given herein below for illustration only, and thus are not limitative of the present invention, and wherein:

FIG. 1 is a schematic view of system architecture of a target in the storage server according to the prior art;

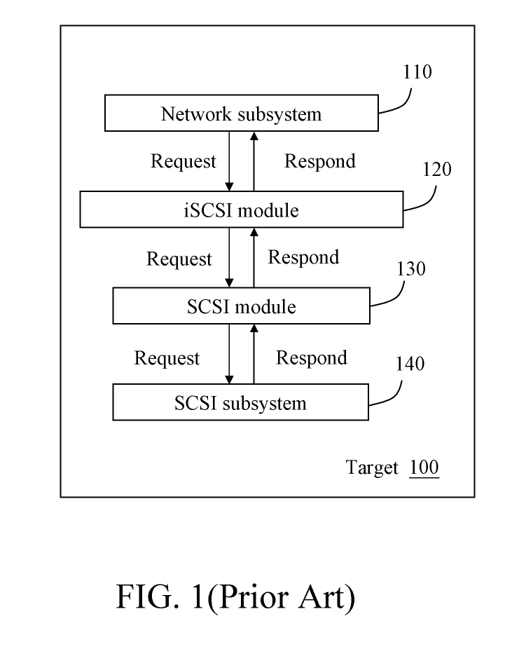

FIG. 2 is a schematic view of system architecture of a target in the storage server according to a preferred embodiment of the present invention;

FIG. 3 is a flow chart of processing the received network packet by the network subsystem according to the preferred embodiment of the present invention; and

FIG. 4 is a flow chart of processing the response instruction by the SCSI subsystem according to the preferred embodiment of the present invention.

### DETAILED DESCRIPTION OF THE INVENTION

The objectives and the implementing methods of the present invention are described in detail in the following preferred embodiments. However, the concept of the present invention can also be used in other scope. The embodiments exemplified as follows are only used for illustrating the objectives and the implementation methods of the present invention, and are not intended to limit the scope of the present invention.

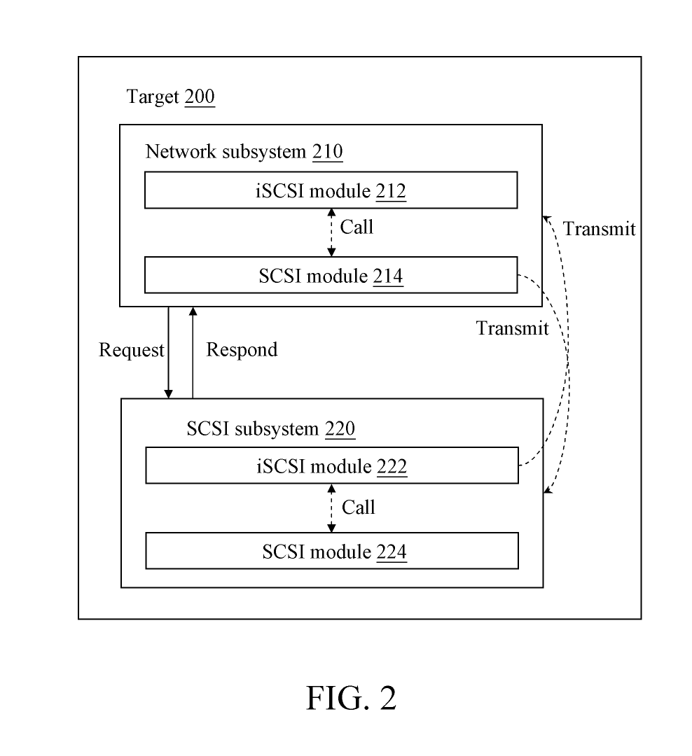

FIG. 2 is a schematic view of system architecture of a target in a storage server according to a preferred embodiment of the present invention. Referring to FIG. 2, in this embodiment, the storage server implemented by the iSCSI in the Linux system is, for example, formed by one or more targets 200. The target 200 includes a network subsystem 210 and a SCSI subsystem 220. An iSCSI module (212, 222) and a SCSI module (214, 224) are embedded in the network subsystem 210 and the SCSI subsystem 220 respectively.

The network subsystem 210 receives the network packet transmitted from the initiator, and the network packet is the data packet of the TCP layer. Next, the network subsystem 210 calls the iSCSI module 212 to determine whether the network packet has the iSCSI request packet, and parse the SCSI request instruction or the SCSI data packed in the iSCSI request packet. The so-called iSCSI request packet is the iSCSI packet containing the iSCSI request instruction. In this embodiment, for example, whether the network packet has the iSCSI file header is determined, so as to quickly determine whether the network packet is the iSCSI packet. Then, the SCSI request instruction or the SCSI data in the iSCSI packet is parsed, so as to determine whether it is the SCSI request packet. Next, the iSCSI module 212 calls the SCSI module 214 to receive the parsed SCSI request instruction or SCSI data, and packs the data to the SCSI identifiable format packet. The iSCSI module calls the interface provided by the SCSI subsystem 220, and transmits the SCSI identifiable format packet to the SCSI subsystem 220.

The independent iSCSI module 222 and the SCSI module 224 are embedded in the SCSI subsystem 220, so the response instruction can be processed in sync without waiting the iSCSI module 222 and the SCSI module 224 to switch from the request end to the response end. After the SCSI subsystem 220 receives the SCSI identifiable format packet, it is determined that the network subsystem identifiable format packet needs to be transmitted to the network subsystem 210 to finish the receiving procedure. The SCSI subsystem 220 firstly calls the SCSI module 224 to determine that the instruction transmitted by the SCSI subsystem 220 is the response instruction. Then, the SCSI module 224 calls the iSCSI module 222, and creates the iSCSI response format data according to the response instruction. Then the SCSI module 224 packs the iSCSI response format data to the network subsystem identifiable format packet and transmits it it to the network subsystem 210. The iSCSI module 222 calls the interface provided by the network subsystem 210, so as to transmit the network subsystem identifiable format packet to the network subsystem 210.

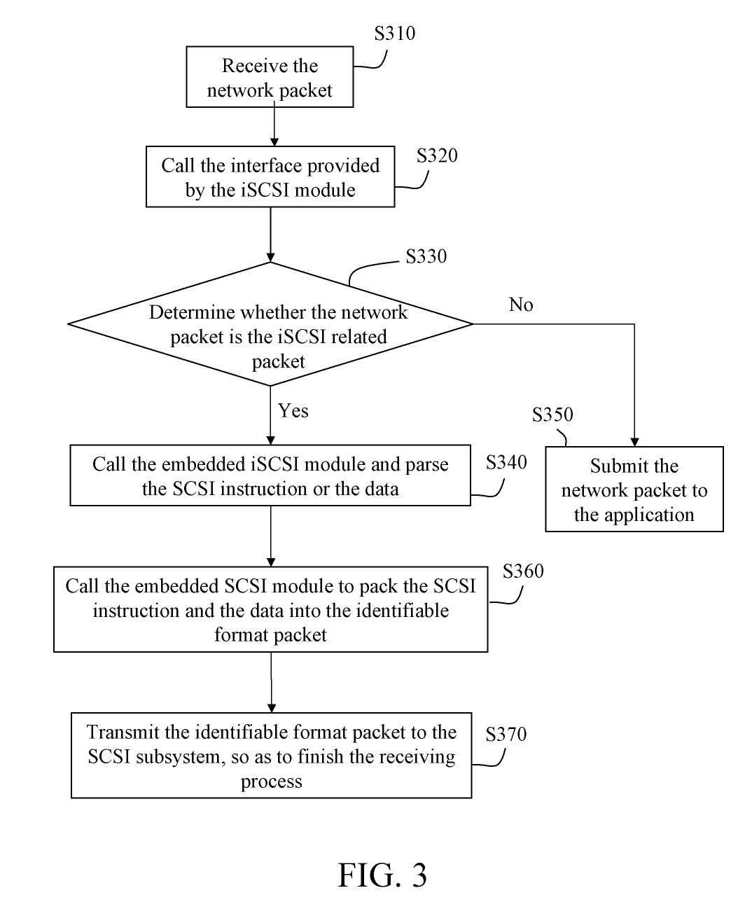

FIG. 3 is a flow chart of processing the received network packet by the network subsystem according to the preferred embodiment of the present invention. Referring to FIG. 3, the initiator transmits a network packet of the session establishing request, and the network packet is first received by the target (step S310). Then, the network subsystem calls the interface provided by the embedded iSCSI module (step S320), and determines whether the network packet is the iSCSI related packet (step S330). If the network packet is the iSCSI related packet (yes in step S330), the SCSI instruction or the data in the iSCSI packet is further parsed by the called iSCSI module (step S340). On the contrary (if not in step S330), the network packet is directly submitted to the related application through the standard flow of processing the network packet by the network subsystem (step S350). For example, when the iSCSI module determines that the network packet is not the iSCSI request packet, the network packet is submitted to the TCP application. Then, the iSCSI module calls the embedded SCSI module to pack the SCSI instruction and the data into the identifiable format packet (step S360) and to transmit the identifiable format packet to the SCSI subsystem, so as to finish the receiving process (step S370).

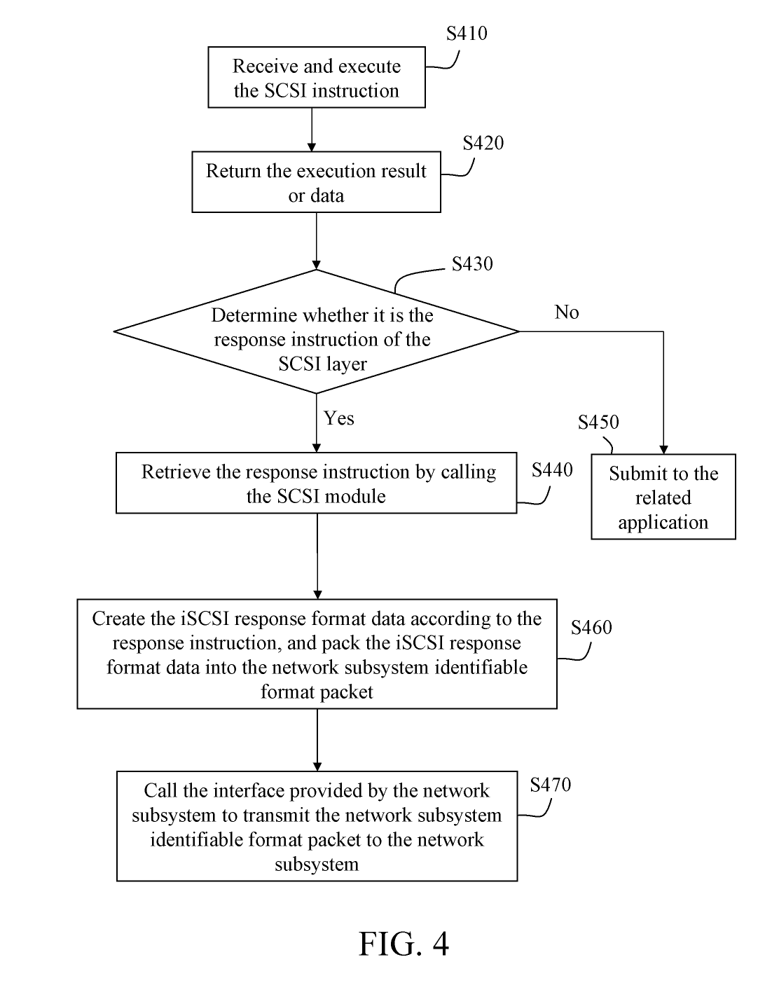

FIG. 4 is a flow chart of processing a response instruction by a SCSI subsystem according to the preferred embodiment of the present invention. Referring to FIG. 4, the SCSI subsystem executes the following steps, so as to perform the process of responding the request packet through the iSCSI module and the SCSI module embedded in the SCSI subsystem. Firstly, the SCSI subsystem receives and executes the SCSI instruction (step S410) and returns the execution result or data (step S420). Then, the SCSI subsystem calls the SCSI module to determine whether it is the response instruction of the SCSI layer (step S430). If yes, the response instruction is retrieved by the called SCSI module (step S440). On the contrary, the execution result or data is directly directly submitted to the related application (step S450). For example, when the SCSI module finds that the instruction transmitted by the SCSI subsystem is not the response instruction, the instruction is directly submitted to the application for execution through the SCSI subsystem standard flow. Then, the SCSI module calls the iSCSI module to create the iSCSI response format data according to the response instruction, and to pack the iSCSI response format data to the network subsystem identifiable format packet (step S460), and calls the interface provided by the network subsystem to transmit the network subsystem identifiable format packet to the network subsystem (step S470).

What is claimed is:

1. A storage server implemented by an internet small computer systems interface (iSCSI) in a Linux system, comprising:
a network subsystem, receiving a network packet from an initiator, and embedded with:
an iSCSI module, called by the network subsystem, for determining whether the network packet has an iSCSI request packet, and parsing a SCSI request instruction or a SCSI data; and
a SCSI module, called by the iSCSI module, for receiving the SCSI request instruction or the SCSI data, and packing into a SCSI identifiable format packet; and
a SCSI subsystem, receiving the SCSI identifiable format packet, and returning a network subsystem identifiable format packet to the network subsystem, so as to finish the receiving procedure, and embedded with:
a SCSI module, called by the SCSI subsystem, and determining whether an instruction transmitted by the SCSI subsystem is a response instruction; and
an iSCSI module, called by the SCSI subsystem, creating an iSCSI response format data according to the response instruction, packing the iSCSI response format data into the network subsystem identifiable format packet, and transmitting the network subsystem identifiable format packet to the network subsystem.

2. The storage server implemented by an iSCSI in a Linux system according to claim 1, wherein when determining that the network packet is not the iSCSI request packet, the iSCSI module embedded in the network subsystem submits the network packet to related TCP application.

3. The storage server implemented by an iSCSI in a Linux system according to claim 1, wherein when determining that the instruction transmitted by the SCSI subsystem is not the response instruction, the SCSI module embedded in the SCSI subsystem directly submits the instruction to the related application.

4. The storage server implemented by an iSCSI in a Linux system according to claim 1, wherein the network packet is a data packet of a TCP layer.

5. The storage server implemented by an iSCSI in a Linux system according to claim 1, wherein the iSCSI request packet is an iSCSI packet containing an iSCSI request instruction.

6. The storage server implemented by an iSCSI in a Linux system according to claim 1, wherein the SCSI module of the network subsystem further calls an interface provided by the SCSI subsystem, so as to transmit the SCSI identifiable format packet to the SCSI subsystem.

7. The storage server implemented by an iSCSI in a Linux system according to claim 1, wherein the iSCSI module of the SCSI subsystem further calls an interface of the network subsystem, so as to transmit the network subsystem identifiable format packet.
